(19) United States
(12) Patent Application Publication
(10) Pub. No.: US 2026/0154934 A1
(43) Pub. Date: Jun. 4, 2026

(54) SYSTEM AND METHODS FOR ANALYSIS OF IMAGE CONTENT AND MACHINE LEARNING PROCESSES FOR DETECTING MACHINE GENERATED IMAGE CONTENT

(71) Applicant: Sony Interactive Entertainment LLC, San Mateo, CA (US)

(72) Inventors: Charles McCoy, San Diego, CA (US); True Xiong, San Diego, CA (US)

(73) Assignee: Sony Interactive Entertainment LLC, San Mateo, CA (US)

(21) Appl. No.: 18/969,015

(22) Filed: Dec. 4, 2024

(51) Int. Cl. G06V 10/60

(52) U.S. Cl. CPC G06V 10/60; G06V 2201/07

(57) ABSTRACT

Systems, processes and device configurations are provided for analyzing and validating image data. Processes include detecting image data, controlling analysis to perform object recognition of a first object in the image data and an operation to determine a characteristic of the first object using the image data and controlling at least one validation operation to verify the characteristic of the first object, the validation operation generating at least one validation output. Processes can also include controlling output of the at least one validation output, wherein the output of the at least one validation operation includes output of at least one graphical element with the image data. Processes and configurations are also provided for labeling and identifying one or more edited image data, generated image data and image data relying too much on seed material.

### FIELD

The present disclosure is directed to image analysis and machine processes for validation of image objects, detection of altered content in images and detection of generated image content, such as generated images and image elements using artificial intelligence, and including machine learning processes and configurations, electronic device or server operations, processes, configurations, user interface control, and control device configurations.

### BACKGROUND

Image data used for various electronic mediums may be produced using digital cameras, mobile devices and even computer programs or applications. Some images may be generated entirely, or in part, using computer programs with generative capabilities, such as artificial intelligence (AI). Other images may be manipulated using editing software or program features sometimes referred to as filters. Images that have been generated or altered, especially by AI, now commonly appear in network applications and electronic forums. Similarly, images that have been edited or are otherwise fake may be common in electronic platforms. There are many cases when these images are problematic, such as when an image is being presented as news or when an image is used in a system that has restrictions on generated or edited image data. Detecting an altered or generated image may be difficult. By way of example, some generated images or digital modifications may be difficult for a person to distinguish. Similarly, some images may copy source material closely and make modifications that may be difficult to detect. Identification of altered content or generated content may be difficult to detect. There is a need and a desire for systems, methods and devices for analysis of image data. There is also a need to provide additional feedback beyond detection of altered image data. Similarly, there is a need to provide electronic features within devices for analysis and identification of altered or generated image data.

### BRIEF SUMMARY OF THE EMBODIMENTS

Disclosed and described herein are systems, methods and configurations for analyzing image data. In one embodiment, a method includes detecting, by a device, image data, and controlling, by the device, at least one analysis operation to analyze the image data, wherein the at least one analysis operation includes an operation to perform object recognition of a first object in the image data and an operation to determine a characteristic of the first object using the image data. The method also includes controlling, by the device, at least one validation operation to verify the characteristic of the first object, the validation operation generating at least one validation output. The method also includes controlling, by the device, output of the at least one validation output, wherein the output of the at least one validation operation includes output of at least one graphical element with the image data.

In one embodiment, detecting image data includes detecting image data in at least one of a data stream, display content and electronic file, and wherein the image data is received by the device.

In one embodiment, the at least one analysis operation to analyze image data includes detecting a lighting characteristic of the first object relative to at least one image area of the image data.

In one embodiment, the at least one analysis operation to analyze image data includes detecting a two-dimensional characteristic of the first object in the image data, and wherein the validation operation includes verifying the characteristic of the first object to at least one parameter characteristic for the first object.

In one embodiment, the at least one analysis operation to analyze image data includes detecting an inconsistency of the object in the image data.

In one embodiment, the at least one analysis operation to analyze image data includes detecting use of preexisting image data.

In one embodiment, the at least one analysis operation to analyze image data includes detecting pixel blur in the image data.

In one embodiment, the at least one analysis operation to analyze image data includes detecting a machine model generated element in the image data.

In one embodiment, the graphical element with the image data identifies at least one characteristic of the first object.

In one embodiment, the method includes controlling at least one machine model to generate reference image data using the object recognition of the first object as input, and wherein controlling at least on validation operation includes comparison of the reference image data to the image data.

Another embodiment is directed to a device configured for analyzing image data. The device includes an interface, memory storing executable instructions, and a controller coupled to the interface and memory. The controller is configured to detect image data, and control at least one analysis operation to analyze the image data, wherein the at least one analysis operation includes an operation to perform object recognition of a first object in the image data and an operation to determine a characteristic of the first object using the image data. The controller is configured to control at least one validation operation to verify the characteristic of the first object. The controller is configured to control output of the at least one validation output, wherein the output of the at least one validation operation includes output of at least one graphical element with the image data.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A illustrates a process and device configuration for image data analysis according to one or more embodiments;

FIG. 1B illustrates a graphical representation of image data analysis according to one or more embodiments;

FIG. 2 illustrates a process for image data analysis and validation output according to one or more embodiments;

FIG. 3 illustrates a graphical representation of a device configuration according to one or more embodiments;

FIG. 4 illustrates a graphical representation of image data analysis according to one or more embodiments;

FIG. 5 illustrates a graphical representation of image analysis training according to one or more embodiments; and

FIG. 6 illustrates a graphical representation of image analysis according to one or more embodiments.

### DETAILED DESCRIPTION OF THE EXEMPLARY EMBODIMENTS

### Overview and Terminology

One aspect of the disclosure is directed to analysis of image data including detecting generated or edited images and image content. Systems, device configurations and processes are provided to detect generated or edited images and to output a validation determination of image data. Output of validations can include output of an identification of one or more portions of an image or the image as a whole that includes generated elements. Outputs can include one or more labels for images or indicators added to images. Output of a validation can include blocking one or more of an image and image portion.

According to embodiments, analysis and validation of image data may include detection of generated and/or manipulated image data. Generated image data may include image data or elements of an image generated by a computing program, artificial intelligence (AI), machine learning programs, etc. For example, generated image data may be image data, such as a file, displayed image, or image content for presentation on a device including one or more elements generated by a computer program. Generated image data may be different from captured image data, such as an image file that is captured by an imaging device (e.g., a camera, etc.). Generated image data may include one or more elements added to captured image data. Unlike captured image data which includes subjects or elements that may be real, generated image data may be artificial or artificially created to depict actions or elements that are not real or that include one or more modifications to real elements. For example, a generated image may include an image of a well-known person or celebrity performing an action that did not occur. Generated images may be created or output using computer programs, such as generated programs or image editing programs. Embodiments described herein may be configured to detect generated images and generated image content. Moreover, embodiments may be configured to detect generated image content in single image frames (e.g., image file, digital photo file, graphical file, etc.) and collections of image frames (e.g., video data, multimedia files, network video data, short video, etc.).

Embodiments are provided for detection of elements to distinguish between unaltered content and content that includes generated image content (e.g., AI generated, generated by a machine model, etc.) or that is altered (e.g., AI generated/altered, generated by a machine model, etc.). Embodiments may use one or more parameters for validation of image data, including use of machine models to detect objects, and detect characteristics of objects and image data in general. Detection of objects in image data may allow for characteristics of the objects to be verified. Similarly, detection of objects may provide a foundation for verification of image content.

Systems, devices and methods are provided for detecting generated or edited images. A system that detects generated or edited images can be used to block or properly label such images in a variety of problematic cases. Generated or edited clips may modify source images to include objects, including persons, or modify objects within an image to change to the representation of a person. Embodiments may detect characteristics of objects to identify modifications. According to embodiments, characteristics of objects may be determined by identifying an object, determining a characteristic of an object in the image data and validation the characteristic. Validations may also detect whether a source image was modified.

According to embodiments, processes may be performed for devices configured to display one or more network applications or by applications executed on devices, such as mobile devices, entertainment devices, and network devices (e.g., servers, etc.). Processes may be employed by one or more applications (e.g., apps) by way of add-ins or application interfaces to allow for receiving image data and outputting validation output to an application user interface. According to embodiments, validation operations may be performed for user interfaces configured for presenting or sharing image content and/or communication data including one or more of voice, text, graphical data (e.g., image, video, meme, audio, etc.). According to embodiments, processes and device configurations are provided for network games, such as multiplayer or cloud-based games, that include one or more streams of player communication. Embodiments can determine and generate one or more notifications and graphical outputs for a user, including output for a user interface of a communication application. By generating and/or outputting one or more validation outputs, notifications may be provided to a user image data presented in an application for gaming and/or communication. Notifications and output discussed herein can transform and/or modify graphical interface elements for one or more of users, such as a player of an electronic game, and viewers of gaming content.

According to embodiments, generating output may include generating one or more graphical elements for a user interface, wherein the underlying image data is not modified, however display elements may include determinations and/or results of the validation operation. Validation operations may include outputs, including graphical, text or image highlighting, to identify one or more images or frames as including generated content. Validation output may be generated to provide feedback, such as warnings or labels on image content. Validation outputs may include adding or modifying display of graphical elements to one or more image elements or graphical display areas.

According to embodiments, processes and device configurations are provided for analyzing image data using one or more generated images. Processes and device configurations can include detection and processing of image using one more models, such as a machine learning (ML) model, to extract and/or detect objects of an image including identifying subjects, categories of objects, objects, components of objects and image characteristics (e.g., lighting, blur, proportions, frame to frame changes, etc.). One or more models may be used to generate images and image data to generate features used to detect elements of a generated image. According to embodiments, non-image characteristics may be used. For example, audio data of video image data may be analyzed for continuity and deviations relative to one or more image frames.

Embodiments are directed to systems, devices and methods for providing interactive services and network operations. By way of example, servers for hosting and/or providing data for one or more network sites and network applications may include operations for analyzing image data. By way of example a server configured to host electronic applications such as a network game may include a chat or communication feature that includes outputs or labeling of shared image content from users. Embodiments may be performed by gaming systems including one or more of consoles and network devices such as servers (e.g., cloud server, network server, back-end server, etc.). Gaming systems may include consoles that play game media, consoles that provide network data for games, handheld devices, mobile devices (e.g., tablets, mobile phones, etc.) and devices in general configured for electronic gaming.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

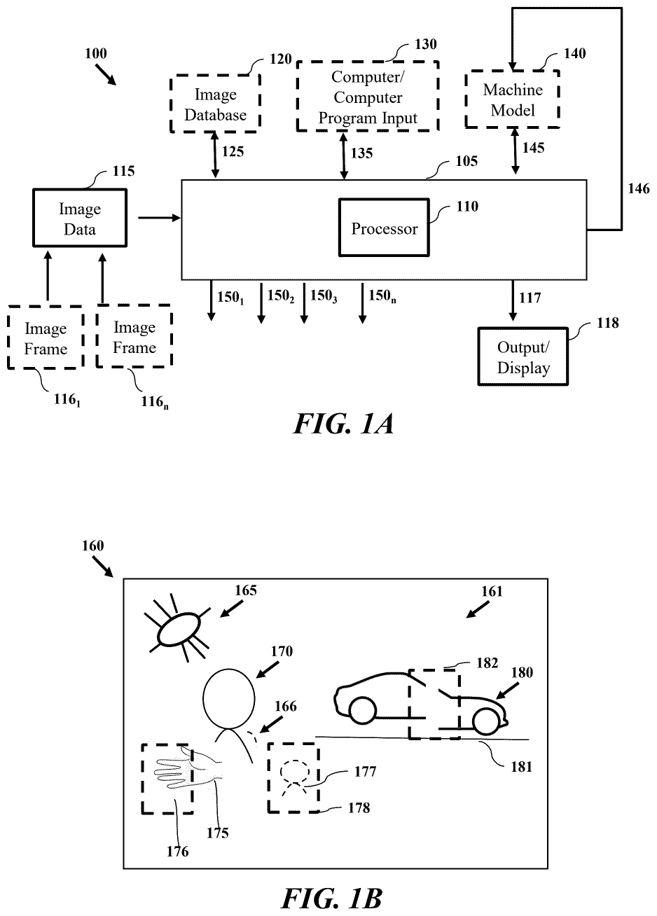

FIG. 1A illustrates process 100 and a device configuration for image data analysis, including analysis of image data. According to embodiments, analysis of image data may include detection of generated or edited images and analysis of image content in general. Image analysis and performance of machine models for validation of image analysis may be performed by one or more operations of process 100 and/or by a device 105. Process 100 may be performed by control devices, such as device 105, which may be a control device (e.g., game console, media player, display device, computer device, mobile device, server, processor, etc.), and/or one or more network devices in communication with device 105. According to embodiments, process 100 may be performed by one or more servers to service one or more control devices. According to embodiments, device 105, which may be a game console, entertainment device, display device or media player, includes processor 110 configured to perform one or more operations or process 100. For network applications, process 100 may be performed by one or more servers, and device 105 may be a network device configured to provide game data to one or more devices, such as network or multiplayer games. According to embodiments, device 105 and one or more servers may be used to output an electronic game for one or more users. According to embodiments, device 105 may perform one or more operations on received game and/or communication data for electronic gaming control.

Process 100 may include device 105 detecting image data 115 and performing at least one analysis operation to analyze image data 115. Process 100 may also include device 105 controlling at least one validation operation based on the image data and controlling output of at least one validation operation, such as output 117.

According to embodiments, analysis and validation of image data by process 100 and device 105 includes detection of generated and/or manipulated elements in image data. Generated image data may include image data or elements of an image generated by a computing program, artificial intelligence (AI), machine learning programs, etc. For example, generated image data may be image data, such as a file, displayed image, or image content for presentation on a device including one or more elements generated by a computer program. Generated image data may be different from captured image data, such as an image file that is captured by an imaging device (e.g., a camera, etc.), or raw image data that is unmodified. Generated image data may include one or more elements added to captured or raw image data. Unlike captured image data which includes subjects or elements that may be real, generated image data may be artificial or artificially created to depict actions or elements that are not real or that include one or more modifications to real elements. For example, a generated image may include an image of a well-known person or celebrity performing an act that did not occur or appearing in location or setting that is computer generated. Generated images may be created or output using computer programs, such as generated programs or image editing programs. Embodiments described herein may be configured to detect generated images and generated image content. Moreover, embodiments may be configured to detect generated image content in single image frames (e.g., image file, digital photo file, graphical file, etc.) and collections of image frames (e.g., video data, multimedia files, network video data, short video, etc.).

Embodiments are provided for detection of elements to distinguish between unaltered content and content that includes generated image content (e.g., AI generated, generated by a machine model, etc.) or that is altered (e.g., AI generated/altered, generated by a machine model, etc.). Embodiments may use one or more parameters for validation of image data, including use of machine models to detect objects, and detect characteristics of objects and image data in general. Detection of objects in image data may allow for characteristics of the objects to be verified. Similarly, detection of objects may provide a foundation for verification of image content.

According to embodiments, process 100 may be performed, and device 105 may be configured, for detecting generated or edited images. System configurations described herein may detect generated or edited images to block or label such images in a variety of problematic cases. Generated or edited clips may modify source images to include objects, including people, or modify objects within an image to change to the representation of a person. Embodiments may detect characteristics of objects, such as a person or inanimate object, to identify modifications. According to embodiments, characteristics of objects may be determined by identifying an object, determining a characteristic of an object in the image data and validation the characteristic. Validations may also detect whether a source image was modified.

According to embodiments, processes may be performed for devices configured to display one or more network applications or by applications executed on devices, such as mobile devices, entertainment devices, and network devices (e.g., servers, etc.). Processes may be employed by one or more applications (e.g., apps) by way of add-ins or application interfaces to allow for receiving one or more of image data, data streams and network data, and outputting one or more validation outputs to an application user interface. According to embodiments, validation operations may be performed for user interfaces configured for presenting or sharing image content and/or communication data including one or more of voice, text, graphical data (e.g., image, video, meme, audio, etc.). According to embodiments, processes and device configurations are provided for network games, such as multiplayer or cloud-based games, that include one or more streams of player communication. Embodiments can determine and generate one or more notifications and graphical outputs for a user, including output for a user interface of a communication application. By generating and/or outputting one or more validation outputs, notifications may be provided to a user image data presented in an application for gaming and/or communication. Notifications and output discussed herein can transform and/or modify graphical interface elements for one or more of users, such as a player of an electronic game, and viewers of gaming content.

According to embodiments, device 105 may detect image data 115 in at least one of a data stream, display content, electronic file and data received by device 105. Image data 115 may include image files, such as digital image files (e.g., JPEG, TIFF, PDF), video files (e.g., AVI, MPG, MPEG-4, etc.) and audio data. Image data may be detected by device 105 based on user applications presenting one or more graphical elements. According to embodiments, one or more of device 105 and process 1110 may execute one or more operating programs and applications that may result in processing or display of images and/or image content. When image data 115 is a fixed image or series of images, one or more of the frames, such as image frames 116₁₋ₙ, may be analyzed. When multiple frames are analyzed, one or more of image frames 116₁₋ₙ of image data 115 may be compared, processed and/or used as input for analysis. When image data 115 includes video data, image frames 116₁₋ₙ in succession or that are separated may be compared and analyzed. Detection of image data 115 may include classifying the type of image data based on file type and type of image (e.g., image captured by a camera, graphic or illustration, image containing captured image content and graphical elements). It may be common for news feeds to include image captured by a camera device with one or more graphical overlays. Beyond detection of the overlays, embodiments may be directed to assessing the validity of captured image data. By way of example, imagery of a person modified by the user or at the user's direction to change the appearance of the user may result in one or more distortions. The modified image may be passed on with the notion that that image is a real depiction. Alternatively, image content may be generated as a whole or in part to attempt to pass on image data as real, when one or more elements of the image have been modified. For example, image data may be doctored for a news story or media feed to support the story. In some cases, these images may be shared on various platforms and in regions that may have restrictions against modified content. Operations of process 100 and processor 110 may be configured to detect modified content, which may include edits or generative content, and output validation determinations for the image data.

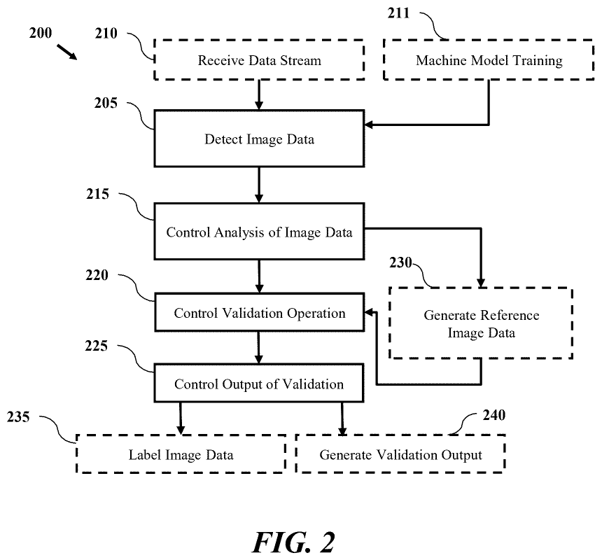

According to embodiments, process 100 may include detection of at least one object in image data. Characteristics of identified objects and image data in general may be used to validate the image data. Process 100 may analyze one or more objects and object characteristics in image data for one or more frames. For example, characteristics of objects may include detecting one or more image quality or pixel characteristics. Pixel blur or pixel regions of objects and features in general in an image may indicate the addition, modification or removal of one or more elements from an image. Similarly, lighting characteristics such as light sources, light distribution, shadows, shadow shapes, and lighting levels (e.g., brightness, darkness, transitions, etc.) may indicate that an image has been manipulated. For objects detected in an image, process 100 and operations herein may be configured to validate if the object confirms to one or more archetypes or characteristics of an identified object. By way of example, if a person is detected, process 100 and operations discussed herein may be configured to identified features of the person an validate if the features confirm to a one or more characteristics of the objects. For a human hand, validation may detect features of the user hand such as the number or arrangement of fingers. If a hand is detected with two thumbs, or more than 5 fingers, or both, the presentation of the hand may be indicative of a generative operation. Similarly, a vehicle that is depicted having a broken or detached body shape may be indicative of a generative process that has been used to generate the vehicle. As discussed below with reference to FIG. 1B, one or more objects may be detected in image data 115. Process 100 may perform one or more processes described herein including process 200 of FIG. 2.

According to embodiments, processor 110 of device 105 may perform and/or control one or more processes, including process 100, for analysis and validation of image data. According to embodiments, machine models may be used and/or controlled by processor 110 to analyze and validate image content. In addition, machine models and image data may be used to generate or identify image data references. By way of example, processor 110 may compare image data 115 to one or more reference images. Embodiments, include identification of similar image data to determine if image data 115 is generated by a machine model. In addition, a machine model may be used to generate image data to compare to image data 115 to determine if generative, manipulated or modified elements are included. According to embodiments, processes and device configurations are provided for analyzing image data using one or more generated images. Processes and device configurations can include detection and processing of image elements using one more models, such as a machine learning (ML) model, to extract and/or detect objects of an image including identifying subjects, categories of objects, components of objects and image characteristics (e.g., lighting, blur, proportions, frame to frame changes, etc.). One or more models may be used to generate images and image data to generate features used to detect elements of a generated image. According to embodiments, non-image characteristics may be used. For example, audio data of video image data may be analyzed for continuity and deviations relative to one or more image frames.

According to embodiments, process 100 performed by processor 110 of device 105 may include receiving reference image data 125 which may be received from image database 120. Reference image data 125 may include one or more existing images that may be accessed by way of a network connection. Reference image data 125 may represent one or more images that may be accessed based on a search, such as an image search. According to embodiments, processor 110 may request an image search of image database 120 based on image data 115. The image search may be based on the image data, a keyword search of objects in the image and/or characteristics detected of image data 115. Processor 110 may generate a request for a search based on image data, objects identified in image data and characteristics of image data 115 to including in a request for a search of image database 120.

According to embodiments, process 100 performed by processor 110 of device 105 may include receiving computer/computer program input image data 135 which may be received from computer/computer program input 130. Computer/computer program input image data 135 may generate one or more images based on a request from processor 110 to generate image data based on one or more objects, characteristics and elements of image data 115. By way of example, if an object is detected with a characteristic, processor 110 may issue a request as input to computer/computer program input 130 to generate one or more reference images based on the input. Processor 110 may use generated images to validate image data 115. By way of further example, when processor 110 detects a key word from image data, such as a name, location, object type, the keyword may be used as the input for computer/computer program input 130. According to embodiments, processor 110 may generate multiple keywords as input for computer/computer program input 130. Computer/computer program input image data 135 may represent one or more images that may be generated to use as references for identifying generated content.

According to embodiments, process 100 performed by processor 110 of device 105 may include using machine model 140 to provide validation data 145 which may be received by processor 110 for analysis of image data. According to embodiments, machine model 140 may relate to computer code executed to detect objects in image data 115. Machine model 140 may also be configured to analyze content of image data 115 to determine characteristics of elements. In some cases, images may appear to be real to a user. Machine mode 140 may run one or more recursive operations to detect image data that is generated by a computer device, image data that is manipulated or processed and image features may be fabricated. According to embodiments, machine model 140 may generate validation data 145 which may indicate one or more features of image data as being generative. Machine model 140 may be used to identify one or more objects in image data 115. Machine model 140 may validate one or more images and image characteristics based on a request from processor 110. According to embodiments, device 105 and processor 110 may receive commands from processor 110, and may receive at least one of image data 115 and reference images (e.g., reference image data 125 computer/computer program input image data 135) for use in validating image data. According to embodiments, processor 110 may communicate with one or more computing devices, such as a network server, for functionalities of machine model 140. According to other embodiments, processor 110 may perform one or more operations of machine model 140. Processor 110 and/or machine model 140 may detect characteristic of image data 115, such as one or more of lighting, pixel blur, object skew and object boundaries. Similarly, processor 110 and/or machine model 140 may identify an object and validate elements of an object. According to embodiments, processor 110 may be configured to detect an object that is represented in a two-dimensional representation (e.g., 2D) and use the 2D representation to generate a three-dimensional (3D) representation. The 3D representation may be analyzed to determine if the 2D representation is valid. By way of example, for a person identified as an object, processor 110 may detect a component of the person, such as an arm and determine if the component conforms to one or more rules for the component. With reference to an arm, an arm would bend at the elbow. When the object is an inanimate object such as a shovel, a component such as a shaft of the shovel would not bend or have a waving structure. Embodiments may apply to additional examples provided herein. Machine model 140 may be configured to validate the characteristics of detected objects and output validation data 145 to processor 110.

According to embodiments, processor 110 may generate output 150₁₋ₙ of validation operations. Output 150₁₋ₙ may include one or more parameters for each validation performed and may include separate metrics for each validation. For example, output 150₁₋ₙ may include a metric or parameter for each of lighting characteristics, comparison to known or generated images, differences in lighting and/or shadows, detection of anomalies in objects, detection of field of depth or focal distance, used of generative technology to generate the image, use of a seed image that is copied too closely and modifications of news or shared media images.

According to embodiments, process 100 and operations of processor 110 may include additional operations described herein, such as operations of process 200 of FIG. 2. Process 100 and processor 110 may be configured to control output of at least one validation output 117. Validation output 117 may include one or more of a label of image data, additions/highlighting/marking of image data to indicate the use of modified imagery and/or blocking of image data 115. Output/display 118 may include validation output 117 to provide users one or more validation determinations of process 100 and processor 110. Output of validations can include output of an identification of one or more portions of an image or the image as a whole that includes generated elements. Outputs can include one or more labels for images or indicators added to images. Output of a validation can include blocking one or more of an image and image portion.

According to embodiments, generating output may include generating one or more graphical elements for a user interface, wherein the underlying image data is not modified, however display elements may include determinations and/or results of the validation operation. Validation operations may include outputs, including graphical, text or image highlighting, to identify one or more images or frames as including generated content. Validation output may be generated to provide feedback, such as warnings or labels on image content. Validation outputs may include adding or modifying display of graphical elements to one or more image elements or graphical display areas.

Device 105 may be configured for presenting game media for a user, receiving user controls and providing user control and game data to a network device, such as a server, for one or more game functions. According to embodiments, a game stream may include data received by and/or provided to device 105 from one or more servers. Game stream data may include image data 115. During operation of a game or applications of a game console, image data may be provided to one or more devices, such as device 105 to allow for presentation of the content. Process 100 and processor 110 may be configured to control presentation of content. Device 105 may be configured to control and present content for one or more users. Device 105 may operate with one or more peripherals or control devices, such as an output device or output/display 118. It should be appreciated that operations and processes that include collection of user data, including user voice and user audio, may be based on expressed consent of a user. Users may be notified of operations and collection of user data. Operations may also require adult confirmation and user agreement for operations to be performed on a console or a device. Embodiments provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

FIG. 1B is a graphical representation of image data analysis according to one or more embodiments. Generated or altered image content may be difficult for many users to detect by viewing the image. Some users may be misled by content of an image when in fact captured image data has been manipulated or the image has been generated (e.g., fabricated by a computer). By way of example, a well-known person, such as a celebrity, athlete, or media personality, may appear in an image or be modified in appearance, wherein one or more details of the image are fabricated or false. In this case, actual image data may be modified relative to captured image data. Similarly, images may be generated to include one or more elements, including but not limited to a person, wherein the depiction of elements is generated by a computer program (e.g., fabricated, generated, artificially created, etc.). Embodiments provide operations to validate images using one or more parameters. In addition, processes and device configurations can provide output to identify modified and/or generated image data.

FIG. 1B illustrates an example image data 160 including image content 161. Image content 161 is exemplary, it should be appreciated that principles of the disclosure may be applied to other image content and image data in general. According to embodiments, processes and device configurations, such as process 100 and device 105, may be configured to analyze image data, such as image data 160. According to embodiments, analysis of image data may be based on characteristics of the image and/or objects identified in the image. According to embodiments, analysis of image data 160 may be performed when image data is presented by a device or when image data is used in a system that has restrictions on generated or edited images. Sometimes a generated image may plagiarize a source that was used for generation of the image. Other situations may include copying a source image too closely or fabricating an image to present objects or situations that did not happen or appear to present content that is modified from a true representation. In some situations, modified content may not be permissible. In other situations, users desire indications of whether image data was modified or fabricated.

According to embodiments, characteristics of image data may be light characteristics, shown as light source 165. Light sources in images may affect the brightness and light dispersion in an image frame. According to embodiments, one or more light sources may be detected, and image data may be validated to determine is light dispersion appears to correlate with light sources in an image. Validation may include detecting light dispersion throughout an image and detecting variations in the light dispersion paths. Light dispersion paths as well as light dispersion relative to one or more objects may be an indicator of one or more added elements to an image and/or modification of elements (e.g., size, shape, etc.) within an image. Brightness of objects varying from brightness of objects in frame may also be an indication of modified content. According to embodiments, validation of the analyzed image data may include identification of lighting elements, lighting sources and/or lighting levels in image data, and detection of lighting relative to detected objects.

According to embodiments, characteristics of image data may be pixel variations, such as pixel blur or artifacts, shown as pixel blur 166. The addition or modification of an existing image may result in one or more lines or border areas of objects that include a pixel disturbance such as color variations, blur and variations object borders. According to embodiments, pixel blur 166 may be detected in image content in general and/or relative to the boundaries of one or more detected objects. According to embodiments, characteristics of image data may be a focus characteristic the image data 161. Focus characteristics may include one or more of a focus setting, such as a focal distance, focus area, depth of field and sharpness of elements in the image data.

According to embodiments, objects of image data may be detected based on the content of elements of image content 161. Object 170 relates to a person or that may be detected in an image. Object detection may include one or more of objected identification, objects shape determination, object boundary determination and detection of features. Detection of two eyes, a nose, a mouth and a face may indicate a human face, were as whiskers, two eyes and a cat shaped nose may be used to identify a cat. Elements of the object may also be determined, such as hand 175. According to embodiments, analysis of image data 160 may include identification of object 170 and object 176, linking object 175 as being part of or associated with object 175 and validation one or more of objects 170 and 175. By way of example, object 175 relates to a human hand and object 170 may be identified as part of a human body. According to embodiments, the features of hand 175 may be validated. Validation may include identifying features that may be associated with the hand, such as number of fingers, arrangement of features, or color of object 175 relative to object 170. When validation the characteristics of object 175, detection of features that do not align with the object may indicate that the element has been modified or is generated content. Embodiments may update or label image data 160 to include one or more graphical elements, such as box 176 for object 175 to identify the object as being generated if determined that the object has been modified or is a generated object.

According to embodiments, analysis of image data 160 may include detection of one or more shadows. Detection of shadows in an image content 161, such as shadow 177 may be based on one or more detected objects. When an object is near or associated with a shadow, such as object 170 and shadow 177 being in close proximity and aligning with a light source 165, the shadow may be a factor in verifying at least the presence of an object in a captured image. Alternatively, a shadow may be detected that is not associated with an object, and thus may be an indication that an object has been removed or modified from image content 161. When identified as including manipulated or generated content, shadow 177 may be marked by a graphical element, such as border 178.

According to embodiments, analysis of image data 160 may include detection of one or more object characteristics. An identified object such as a shovel including a straight shaft or a vehicle having a continuous structure may be indications of a validated object. However, detecting of breaks in structural elements, distorted structural elements and shapes not associated with an object may be indicators that the object and/or image data as a whole are generated. Detection of object 180, representing a car, in an image content 161, may be analyzed to determine if the shape or body features comport with a vehicle. In some images, angles of an object may make it difficult to determine the shape or features of a vehicle. For example, a back angled view of the object may be more difficult to detect vehicle shape. However, certain features of the vehicle may still be verified. Other angles of view of the vehicle allow for validating the representation of the vehicle and vehicle components, such as a body line or structure. Vehicle 180 is shown relative to surface 181. Surface 181, which may be a ground surface, may be detected and used to validate the appearance of other objects. Vehicle 180 is shown having a separate and/or bent structure that is identified by border 182.

According to embodiments, operations and device configuration include detection of two-dimensional representations of objects, such as objects 161 and comparing the two-dimensional representation to a characteristic of a three-dimensional representation. By way of example, detection of object 175 may include identification of the object and identification of at least one three-dimensional characteristic of the object. Using the at least one three-dimensional characteristic of the object, the appearance and characteristics of the two-dimensional representation may be validated. Object 180 may similarly be evaluated, wherein the two-dimensional representation in image data 161 may be detected and one or more characteristics of the two-dimensional representation may be validated against three-dimensional characteristics of the object. According to embodiments, the two-dimensional element may be converted as represented in the two-dimensional image data to a three-dimensional representation to determine if the representation would represent attributes of an object.

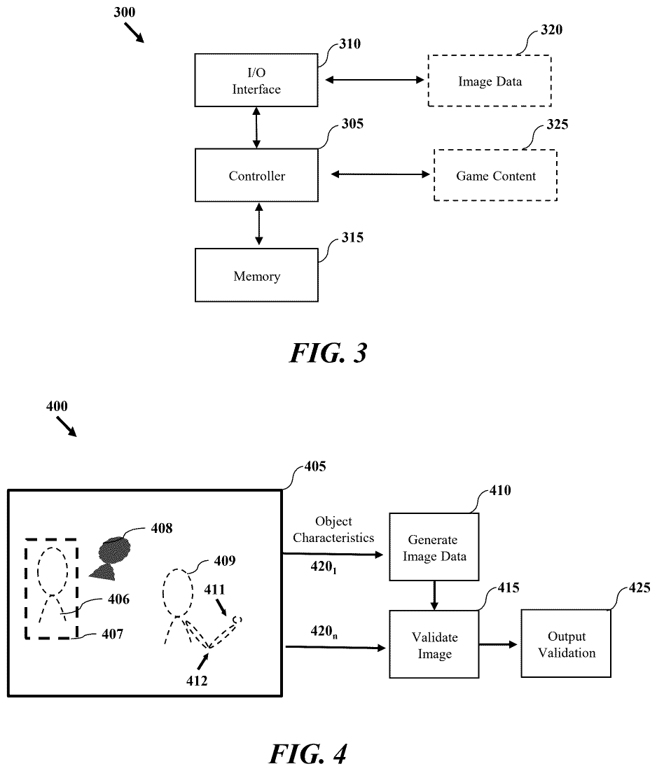

FIG. 2 illustrates a process for image data analysis and validation output according to one or more embodiments. Process 200 may determine analyze image data including one or more images. Image analysis may be performed for applications presenting graphical content, including network communication applications, social media applications and electronic gaming applications. In addition, process 200 may detect objects and characteristics of image data to provide one or more validation outputs to characterize modification of image data, or inclusion of generated content, such as computer-generated images. Process 200 may be performed by a device, such as device 105 of FIG. 1A, controller 305 of FIG. 3, or a control device in general.

Process 200 may be performed in association with one more application. Many images shared in electronic applications are edited or processed. In some cases, images may be entirely fabricated, and it may be difficult to determine if an image is generated by a computer, as opposed to be captured by a camera. Alternatively, objects in images may be modified or if the content in the image has been manipulated or processed. Modified and generated images may be shared by way of personal electronic devices and applications on personal devices (e.g., mobile device, tablet, etc.) and entertainment devices (e.g., game console, media player, display device, etc.). Process 200 can perform operations to determine validity of image data, wherein the validity may include a determination if one or more object or the picture as a whole are generated by a computer program or a device, as opposed to capture by a camera device. Generated may refer to use of one or more editing, modifying, or generative operations for image data. Some camera devices, such as mobile devices may employ computer code, sometimes referred to as a filter, to modify the capture of image data. As such, the filter generated image may be a generated image or modified image, as data captured by the camera of the device is modified and/or processed. Analysis and validation by process 200 may look at fake images. modified image data and/or images containing generated content and determine one or more validation determinations. Validation operators may provide an estimation of authenticity. Validation output may present indicators or graphical elements to highlight areas or objects in images that appear to be generated of modified. Process 200 may be configured to distinguish a generated image from graphical content (e.g., computer illustrations). According to embodiments, process 200 is a form of image processing to detect manipulation of image content.

Process 200 may be initiated by a device detecting image data at block 205.

When performed by a network device, such as server 135, the game stream data may include data received from one or more user devices, such as game consoles or media players. The server device may be configured to process game streams from users to determine one or more game actions and data to broadcast to users of a multiplayer game. When performed by a control device local to or associated with a user, such as device 105 associated with user 115, the game data stream may include one or more components for presentation of a game. Control devices and consoles may include media or game data local to presentation of a game, the game media configured to receive one or more game data streams to allow for multiplayer gameplay. Process 200 is described below as being performed by a device. According to embodiments, process 200 may be performed by one or more of control devices, consoles and network devices such as servers.

At block 205, process 200 includes detecting image data. Detecting image data includes detecting image data in at least one of a data stream, display content and electronic file, and wherein the image data is received by the device. Image data may be detected by a device based on a graphical image presented on a display and/or based on one more data inputs. Detection of image data at block 105 may be based on a user request to analyze image content. According to other embodiments, process 200 may be performed by a device during device operation, such that detection of image data at block 205 may be performed in response to presentation of graphical content by a device and/or detection of image data in one or more data streams. Accordingly, detection of image data can include detection onscreen display of image data. This image data and as used herein may be a still image, video image data, and graphical content in general. Detected image data may be from a file, such as one or more image file formats, like jpeg, gif, etc. Image data may be part of a stream of data, such as video stream, a portion of a video stream. Image data may be detected by a device presenting content. In some cases detecting image data may be part of one or more processes for such as processing and presentation of graphical, entertainment or media content. Processing may include processing a data feed. Processing may include processing input, such as one or more of a file and network address

At block 210, process 200 may optionally include receive a data stream. A data stream received at block 210 may be from a network device, including data associated with a network location and/or provided by a network server. Receiving a data stream at block 210 may include receiving a game data stream for an electronic game, the game data stream including game data for at least one user of the electronic game. For example, the game data stream can include one or more of graphics, code to direct graphics, audio data, and code describing audio to present for a game.

At block 211, process 200 may optionally include machine model training. According to embodiments, machine model training may be performed by process 200 to identify objects and characteristics of objects in image data. Process 200 may utilize one or more data processes and image analysis models generated from machine model training at block 211. Machine model training for example may be performed and used by process 200 to analyze one or more of image pixels, pixels groupings and object identification in image data. Machine model training may also be used to generate one or more characteristics associated with objects. For example, placement of facial features on a user face, or hinge points of a person's body, anatomical characteristics and mechanical characteristics of objects.

At block 215, process 200 includes controlling, by the device, at least one analysis operation to analyze the image data, wherein the at least one analysis operation includes an operation to perform object recognition of a first object in the image data and an operation to determine a characteristic of the first object using the image data. According to embodiments, process 200 may employ one or more operations and processes to analysis image data. At block 215, for example, process 200 may include one or more of light analysis in the image data, image quality assessments, such as changes in pixel blur, and character analysis of one or more objects detected. Analysis of image data using one or more objects or object characteristics may include identifying one or more objects in image data. Object identification may be performed with respect to one or more analysis windows such as at a pixel level, pixel grouping, and detection of objects in general in an image. Object identification may use one or more machine learning models and elements obtained during training of process 200. Analysis may include identification of one or more characteristics of the object. Objects such as one or more of a person, particular person, animal, inanimate object (e.g., shovel, blanket, car, furniture, etc.) and both real and graphical elements may be identified in an image. In addition, one or more characteristics of the object may be identified which may include one or more elements of an object. By way of example, for a person, one or more characteristics determined may include hair color, identification of the particular person, such as name or resemble to another image, eye color, body tone, facial expression, etc. Characteristics of may also be determined for components of the object, such as an arm, hand, fingers, and arrangement or positioning of the body component.

According to embodiments, process 200 may perform at least one analysis operation to analyze image data includes detecting a lighting characteristic of the first object relative to at least one image area of the image data. Process 200 may analyze light distribution in an image, including one or more of a lighting level (e.g., dark, indoor, bright, outdoor, etc.) by examining the brightness levels of pixels. Lighting characteristics of an object may be evaluated compared to one or more portions of the image data, such as the image frame as a whole, or one or more surrounding areas of the object. By way of example, a modified or generated image may include an object (e.g., a person) having a first lighting characteristic, with one or more other objects having a different lighting characteristic. Different lighting characteristics may be detected using brightness or color of an object. Alternatively, or in combination, lighting direction which may be detected by detecting one or more shadows of objects and comparing where a shadow should be present compared to the presence or shadows in an image. Shadows may be a characteristic of an object detected by process 200.

According to embodiments, characteristics of objects may be detected to verify and analyze the image content. According to embodiments, at least one analysis operation may be performed by process 200 to analyze image data by detecting a two-dimensional characteristic of the first object in the image data, and the validation operation can include verifying the characteristic of the first object to at least one parameter characteristic for the first object. With respect to people, if the characteristic of an object is an arm or arm position, validation can include determining if the arm includes characteristics associated with human arms, such as a hinge point or elbow and movements and/or arrangements consistent with how a human arm interacts. Similarly, if an object is detected included a rigid structural element, such as a vehicle body or shovel, validation may include detecting if the rigid structural element includes bends or changes in shape that are not consistent with the object. For example, a spade shovel with a drooping handle of a vehicle with an inconsistent body may indicate that the object is machine generated and/or that the image has been manipulated. Process 200 may be configured to perform at least one analysis operation to analyze image data includes detecting an inconsistency of the object in the image data. Inconsistencies may be based on one or more of lighting, a blur/pixel distortion and inconsistency with the object characteristics. For some objects, inconsistencies may be based on criteria assigned or associated with an object. For example, a human hand that is detected may be analyzed to determine that it does not include more than five finger.

According to embodiments, process 200 may analyze and validate objects by using at least one analysis operation to analyze image data includes detecting pixel blur in the image data. Pixel blur may be one or more regions of pixels in an image that create a distortion between objects in image data. By way of example, the outline of an object may appear to include distorted variations in pixels compared relative to other objects in the image. Pixel blur may be an indication of modified image content due to adding elements to an image.

According to embodiments, process 200 may analyze and validate objects by detecting an object as a two-dimensional (2D) representation, detecting a characteristic of the object and validating whether a 2D feature complies with a 3D representation. By way of example, a human hand may be detected as an object and characteristic of the human hand may be 5 fingers as detected in a 2D representation. Process 200 may convert or analyze the features in a three-dimensional (3D) representation to determine if the 2D representation is valid. For example, with a five fingered hand in 2D, conversion to a 3D representation or analysis with respect to a 3D arrangement may illustrate that the hand includes one or more fingers in an anatomically incorrect position. In that case, the hand may be flagged or labeled as appearing to be generated or manipulated. Similarly, facial features detected in 2D may be compared to a 3D representation or to determine if the location or one or more elements of a face, such as eyes, ears, nose, mouth, eyebrows, etc. would appear in the correct orientation in a 3D model.

According to embodiments, analysis at block 215 may include determining if image data is preexisting in part or as a whole. According to embodiments, the at least one analysis operation to analyze image data includes detecting use of preexisting image data may include detecting one or more objects in the image and performing a search by way of one or more network databases to detect if the image data is preexisting. Preexisting data may be added to an image, and/or may be used as a base to modify content. Examples include using an image or a person or part of a person and layering that image over other image data. Similarly, an image may include an object or scenario where one or more objects in the image are modified to include a changed appearance. Use of preexisting image data may include using at least one pixel group, or image as a whole to perform a search and/or searching based on the content of the image. According to embodiments, a machine model may be used by the at least one analysis operation to analyze image data. By way of example, detected objects may be used as input to generate an image and determine similarities between one or more generated images to an input image. Detection of machine model generated elements in the image data, such as objects, pixel layering, image metadata, etc. may be indicated of generated image content.

At block 220, process 200 includes controlling at least one validation operation to verify the characteristic of the first object. Validation operations can include using analysis of objects in block 215 to make a determination of whether image content is manipulated, modified, and/or machine generated in part or as a whole. Validation at block 220 may be performed to determine image elements and features on an object-by-object basis and for one or more characteristics of detected objects. Image data, even when captured by a camera may include one or more aberrations or inconsistencies. For example, a user moving a camera during image capture may generate blur in the image content. Image blur from motion may result in large portions of the image to include pixel blur. Conversely adding an object to an image or merging image content may result in images with different backgrounds or boundaries detected. According to embodiments, validation at block 220 may assess a plurality of image characteristics and determinations of manipulated and/or modified content may be labeled to identify the object or characteristic flagged and the rationale for an object to be flagged or labeled as modified.

Validation at block 220 may be based on identified objects in image data and can include one or more of detection of object features, validation of identified objects, and validation of detected objects and image data in general. Validation at block 220 may assess the detected objects and image characteristics determined by analysis at block 215. Similar to analysis at block 215, validation may use one or more detected characteristics to determine image content that has been modified from raw data and/or generated by a device. Validation at block 220 may identify if one or more characteristics appear to be modified or generated and generate one or more labels or graphical elements to identify modified image data. Validation at block 225 and one or more identifications may be provided for characteristics or factors such as lighting, blur and focal distance. Validation of lighting in the image content may include assigning a depth to an object, assign a distance or depth to reference point in the image data and processing lighting characteristics for the depths to object and depth to reference point for one or more of lighting, blur, coloration and proportions of objects. Validation of lighting characteristics in image data may include detection of shadows in images, wherein shadows may be indicators of objects and outputting an identification of shadows not matching objects in the image content.

According to embodiments, validation at block 220 may include validation of pixel variations detected at block 215. Detection of an orphan pixel grouping, such as a collection of pixel data that does not correlate with other areas of the image data, may be a basis for identifying generated content. For example, the orphan pixel grouping may be assorted with modified image data and not resemble or present similar to other pixel groupings in image data. According to embodiments, validation may include generating one or more labels and descriptions of anomalies between detected 2D characteristics and converted representations to 3D.

According to embodiments, validation at block 220 may assess image content relative to content of a data stream and/or the source of image data. For example, image content in a news story or shared media may include text, audio or other elements characterizing the image content. The image content may be analyzed at block 215 and a validation operation at block 220 may determine if the image supports and/or corroborates the news story or shared media. In situations where shared image content includes image data that has been modified or generated, the validation operation at block 220 may determine that image data should be labeled and/or marked as including modified image content. In additional to news or media streams, image data in one or more network applications, such as social media fees and social media posts may be validated at block 220.

According to embodiments, control of validation operation at block 220 may detect differences in image content processing presented by an imaging device and image data that is generated. By way of example, raw image data may be processed or modified by image capture applications to adjust lighting, change focus, and even add effects such as filters. Generative image data may generate to appear real and may also include effects or filters, however, the underlying source material may not be raw image data, but image data generated by a machine. Validation operations at block 220 may determine if image content includes one or more of image effects, filter and generative content.

According to embodiments, validation at block 220 may determine if image data received at block 205 uses or relies on a seed image. In some cases, modified image data may be based on an existing image that may be known associated with a particular source. The known image data or seed image data may be modified to change the message or use the style of the image data. At block 220, validation may detect objects, colors used, arrangement of objects and or text to detect if image data is based on an existing image.

At block 225, process 200 includes controlling, by the device, output of a determination of the at least one validation operation. Determinations may include one or more outputs that identify results of analysis of image data at block 215 and/or validation operations at block 220. Determinations of the at least one validation operation can include an identification of the first object. For example, process 200 may identify at least one object for outputting a validation. Objects identified may be a person or face in an image. Objects may include an inanimate object or item in a figure (e.g., shovel, chair, car, etc.). According to embodiments, objects may include one or more characteristics or features of objects, such as a shadow, pixel boarder, object position, etc. In addition, objects identified may be one or more regions of an image frame or characteristics of the image frame. According to embodiments, output of a determination includes output of at least one graphical element with the image data. The at least one graphical element may be presented to identify a characteristic of the first object. Output of validations at block 225 may be for a plurality of objects. Outputs at block 225 may include a plurality of determinations for each object. For example, for an object identified as a person, the validation output may indicate that the persons face has one or more misplaced features, an incorrect shadow and/or lighting that differs from other elements in the image. Outputs at block 225 may include one or more confidence ratings determined at block 225. The confidence rating may be an estimation or a calculated value and can provide a rating or value associated with a scale or description of the degree of modification. Confidence ratings may be a scale (e.g., 1-100) or include categories or symbols (e.g., low, medium, high, etc.) indicating the confidence in the validation. Output of a validation at block 225 may include the confidence rating.

According to embodiments, output at block 225 may include an identification of one or more areas of image data that appear to be manipulated. Output can include a graphical indicator to highlight or identify one or more areas that include modified image content. Identifiers may be provided including a shape (e.g., box, arrow, etc.), color, or indicator in general

Validation outputs at block 225 may also indicate that image data includes already existing image data. At block 230, process 200 may generate reference image data. Reference data may be generated by process 200 to aid in evaluating whether image data include generative content. Based on one or more objects or characteristics of image data determine at block 215, a reference image data may be generated at block 230. Multiple reference images may be generated at block 230 and used for validation at block 220. At block 230, process 200 may control at least one machine model to generate reference image data using the object recognition of the first object as input. Controlling at least on validation operation at block 220 may include comparison of the reference image data to the image data detected at block 205.

At block 235, process 200 may optionally label image data. Labeling image data at block 235 may include generating one or more of an image labels, image element, and data for an image to identify which portions of image data in an image frame and/or objects include generative or modified image data. Output of a label at block 235 can be to an image frame. For video content, the video data may include a series of image frames and differences relative to one or more frames may be noted between a series of real images put together.

At block 240, process 200 may optionally generate validation output to provide a description of the validation operations. Validation output may include one or more parameters that may be used by applications and/or devices to output a message (e.g., graphic, warning, text, etc.) regarding the results of the image. By way of example, the validation output may include one or more of identification of an object, a characteristic of the object, an evidence that the object is manipulated or generated and a confidence rating of the validation. Applications on a device and/or network applications may use the validation output to generate output for a user and/or other application functions. At block 240, process 200 may block an image and/or generate a command or function to block presentation of an image based on the result of the validation. By way of example, if image data includes seed material and relies too much on the seed image, the image may be blocked. Similarly, if image content is manipulated or generated, the image data may be blocked in order to comply with one or more of system and user settings.

FIG. 3 illustrates a graphical representation of a device configuration according to one or more embodiments. Device 300 is configured for analyzing image data. Device 300 can provide one or more components and functions of device 105 in FIG. 1. Device 300 may represent one or more of a gaming console, computing device and electronic device in general configured to output one or more of video, audio and game data to an output device. Device 300 may provide one or more components of a server or network device.

Device 300 may be a control device or game console device which can include controller 305, memory 315 and input/output (I/O) interface 320. Device 300 may also optionally include game content 310. Controller 305 may relate to a processor or control device configured to execute one or more operations stored in memory 315, such as processes for analyzing and validating image data. Memory 315 may be non-transitory memory configured to provide data storage and working memory operations for device 300. Memory 315 may be configured to store computer readable instructions for execution by controller 305 for one or more processes described herein.

Device 300 may be configured to receive data streams, such as gaming media (e.g., card, cartridge, disk, etc.), and output visual and audio content of the data streams to an output device, such as a display. Device 300 may be configured to provide image analysis features for users of the device, application and network applications in general on the device, such as a communication or media sharing applications. Controller 305 may be configured to receive image data by way of I/O interface 320. Controller 305 may also be configured for analysis and validation of image data and one or more data streams including image data. Controller 305 may be configured to control a machine learning model for analysis and processing of image data.

Controller 305 may be configured to receive data, such as image data, from one or more other devices such as console and servers to present and output content including image data. For image data received over a network, controller 305 may receive image data from a network source, such as a server, by way of the network and I/O interface 310 which may connect to the network by wired or wireless connection. Controller 305 may be configured to receive input from one or more peripheral devices. Functions performed by controller 305 may be for network operations, such as web browsing, communication applications, social media and content streaming services. Processes and device configurations may be performed by way of an application add in to interface with network applications. For example, an application for social media browsing may interface with controller by one or more application programming interfaces. Image data in the social media browsing may be detected by controller 305 for analysis and validation. Controller 305 may output validation outputs to the social media browsing application. Validation outputs may be displayed by the device and validation may be based on user selection or input commands including requests or inputs to detect if images are altered or generated. Systems may be configured to analyze image data, such as pixels, and the content or objects represented in the image data. By performing object analysis, features of the objects may be assessed to better characterize both edited content and generated image content.

FIG. 4 illustrates a graphical representation of image data analysis according to one or more embodiments. Image data 405 may relate to an image frame or frames of image data. Image data 405 may include one or more objects, such as people, inanimate objects, landscapes, backgrounds and may be based on raw image data captured by a device (e.g., camera, optical sensor, etc.) and image data generated by a computer program on a machine. Image data 405 includes objects 406 and 409 which may be detected according to processes and device configurations discussed herein. Detection of objects 406 and 409 may be based on image processing including object identification. According to embodiments, object detection may include identification of the object. By way of example, object 406 may be identified as a person or a portion of a person. Embodiments may also detect characteristics of the object, such as characteristics of object 406 may be detected to include proportions, identification of anatomical features such as facial features, number of fingers, etc. According to embodiments, analysis of the image may detect light distributions and shadows associated with an object to determine is the object has been modified or generated. By way of example, shadow 408 which includes pixels or pixels colors that indicate a shadow of object 406 may be identified and processes may determine if the shadows correspond to object 406. When shadows appear in an image and an object does not have a shadow, the absence of the shadow may indicate that the object was added to the image. Similarly, when the shadow of an object does not correlate to the position, is discontinuous, or varies from the object location, shadow 408 may indicate that object 406 has been manipulated. According to embodiments, boundary 407 may be added to image data 405 to indicate the presence of object 406 as including edited and/or manipulated object 406.

According to embodiments, object detection may include identification and validation of characteristic of objects. Object 409 may be detected in image data 405 and identified as a person. Based on the identification of object 409 as a person, analysis and/or validation may include identification of characteristics of the object 409. As shown in FIG. 4, an arm 411 of object 409 may be identified and hinge point 412 of arm 411 may be identified. Validation of image data 405 may include determining if the characteristics of object 409 are valid. By way of example, arm 411 may be identified as having hinge point 412 in an incorrect position. Alternatively, hinge point 412 may be determined to bend in an incorrect (e.g., anatomically incorrect manner).

FIG. 4 illustrations process 400 which may include receiving image data 405 and identification of object characteristics 420₁₋ₙ. Object characteristics 420₁₋ₙ may be determined based on objects identified in image data 405, such as objects 406 and 409. According to embodiments, object characteristics 420₁₋ₙ may be used to generate a reference image for comparing and/or validating image data 405. At block 410, based on identification of objects 406 and 409, and characteristics 420₁₋ₙ, one or more images may be generated using one or more of a description of the image (e.g., text description, object identification, pixel profile, etc.). At block 415, process 400 may validate image data 405 to determine if characteristics 420₁₋ₙ indicate the image has been modified or generated. Generated image data at block 410 may be used for validation at block 415. At block 425, process 400 may output one or more validation determinations.

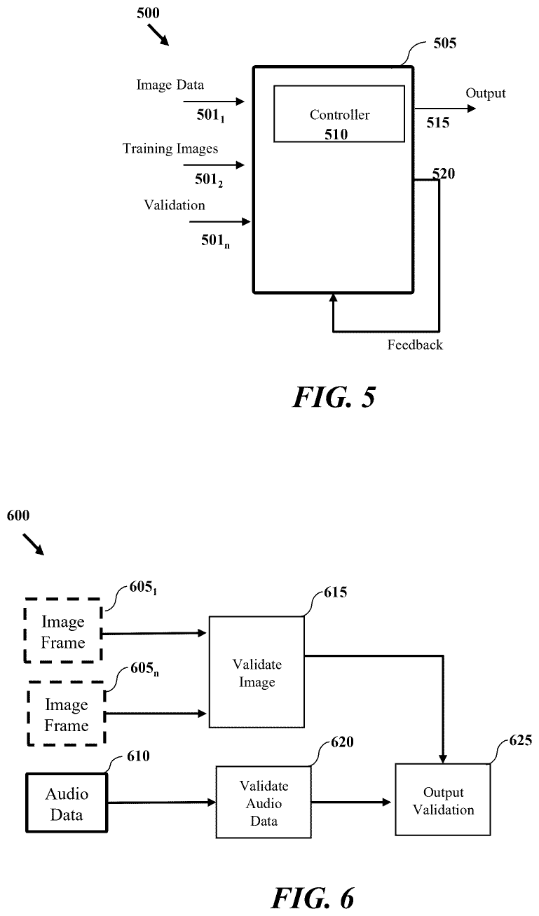

FIG. 5 illustrates a graphical representation of image analysis training according to one or more embodiments. Process 500 may be performed to detect objects and validate objects in image data. Once an object is determined, image data and characteristics of the image data may be used to determine if image data includes modified or generated image data.

FIG. 5 illustrates training process 500 which can include receiving training parameters 501₁₋ₙ as training input by a device 505 including a controller 510. According to embodiments, controller 510 may receive a plurality of forms of image data 501ₙ providing image data samples as training input, including raw image data, modified image data and generated image data. Training data 501₂ may include specific images providing samples of identified image data, such as image data including purely generated image data, and/or modified image data in order to provide examples of how image data may be modified. Validation data 501ₙ may be provided as examples of validations to provide or indicate as output. Based on the training in process 500, controller 510 may generate output 515. Output 515 may include one or more analysis determinations, objects identified, validation determinations, and markups or labeling of image data. According to embodiments, controller 510 may be configured to generate output 515 based on a recursive loop including training and feedback. Feedback loop 520 may provide information such as ratings and accuracy for output 515.

According to embodiments, training by process 500 may be used by processes described herein. Device 505 and controller 510 (e.g., processor) may use one or more machine models for image analysis, generation of machine models for image analysis and train on known unaltered data sets and with generated or edited data sets to generate one or more machine learning models and machine tools to detect image modification. Process 500 may be trained and operated to detect generated or edited images and can be used to block or label image data.

According to embodiments, process 500 may include training on altered images. Using the altered images, process 500 may be trained to identify objects and image data. According to embodiments, image function may be identified to determine the type of image (e.g., portrait, landscape, action, social media, meme, news story, etc.). Image function may be detected to determine objects in both two dimensional representations and three-dimensional representations. By way of example, by identifying an object and the function of the object in the image, the characteristics of the object may be validated. For example, body lines of a vehicle that is undamaged may have continuous body lines while a wrecked vehicle may include disassociated parts. Similarly, when a person is identified in image data process 500 may be trained to detect anatomical characteristics, such as number of fingers, and finger arrangement. Training can include training a controller to convert two-dimensional image data to a three-dimensional representation to verify that the two-dimensional representation is valid. Anomalies may be detected between what is depicted and a two-dimensional representation of a coherent three-dimensional model. Most generated images do not generate image data associated with a three-dimensional object, as such conversion of a two-dimensional object to a three-dimensional object can reveal inconsistencies or fabrications of a generated image. For example, extra fingers on what should be a human hand, which is a three-dimensional object consisting of one thumb and five fingers. Similarly, non-symmetric bodies, such as significant differences in the sizes or shapes of the left and right body parts of the same body (e.g., ears, limbs, eyes, etc.).

Process 500 may include training to detect differences in lighting, such as inconsistencies in shadows, odd angles, such as things that are normally 90° angles are other angles, perspective inconsistencies, such as the distance and angle of the camera to a first image to correspond to the rendering of the first object in an image conflicting with what the distance and angle of the camera would need to be for the rendering of a second object in the image. Process 500 may include training to detect common three-dimensional objects depicted in a two-dimensional image, such as a shovel, blanket, or human arm. The system can then determine if the objects in the two-dimensional image correspond to the corresponding recognized object, such as a shovel does not bend, a blanket drapes over things, while an arm only bends at the elbow.

Process 500 may include training to detect focal distance and depth of field anomalies in an image, such as if one of the objects in the background is in sharper focus than the others or a portion of the foreground is blurrier than other portions of the foreground at the same distance from the viewpoint.

Process 500 may include training to detect if an image contains plagiarism, such as if it relies too much on a seed that was used in the generated of the image. Processes may detect significant similarities between an image and a set of images that it was trained on. Detected matches can be labeled as likely plagiarism or may be subject to further scrutiny. Image fingerprinting may be used to determine if too much of a source image ends up in a generated image. Determination of if an image is too similar can be based on many factors, such as overall composition, art style, specific look, or particular elements that are too similar to elements in a source. Techniques applied to images can also be applicable to videos —audio data can be analyzed by AI in a similar manner to image or video data. An edited image may be determined based on a system being familiar with the original source that the fake is based on, such as detecting a constructed meme based on recognizing the image the meme is based on.

Process 500 may continually train on the latest media, such as news feeds, to be able to detect edited images, such as fake news, based on those images. When analyzing a video, a system can detect a point where an aspect suddenly changes when there is not a scene cut, such as a movement that is not continuous or movement of an object in the scene not corresponding to movement of the camera. Similarly, differences in audio qualities can be used when analyzing audio, which may be part of a video, such as volume level, frequency distribution (such as the bass getting quieter), timber (wave form shape), reverb or other sound reflections, background or ambient sounds, pitch used for a voice, speech speed, or emotions expressed by a voice.

According to embodiments, training process 500 and controller 510 may be configured to use one or more learning models (e.g., artificial intelligence, iterative models, etc.) to game audio. Training process 500 and controller 510 may use one or more libraries of game audio examples. According to embodiments, output 515 may include output of game audio modified based on one or more sound cues.

FIG. 6 illustrates a graphical representation of image analysis according to one or more embodiments. According to embodiments, validation of image data may include analyzing and validating multiple frames of image data. According to embodiments, validation of image data may include analyzing and validating audio data. Process 600 may include receiving a plurality of image frames 605₁₋ₙ. Process 600 may also receive audio data 610. Audio data 610 may be audio associated with image data of the plurality of image frames 605₁₋ₙ. At block 615, process 600 may validate image data. Similarly at block 620, process 600 may validate audio data. According to embodiments, variations detected in frames, such as a group of frames, sequential frames or non-sequential frames may be used to characterize and determine if image content has been modified or generated. By way of example, in some cases generated video data may appear to be genuine in certain frames, but subsequent frames can reveal that the video or image data has been generated. Similarly, audio of video image data may appear to be genuine for legitimate image data, however, the audio may be added, edited, manipulated or generated. Output validation at block 625 may provide one or more outputs indicating analysis and processing of image frames 605₁₋ₙ and audio data 610.

While this disclosure has been particularly shown and described with references to exemplary embodiments thereof, it will be understood by those skilled in the art that various changes in form and details may be made therein without departing from the scope of the claimed embodiments.

What is claimed is:

1. A method for analyzing image data, the method comprising:
detecting, by a device, image data;
controlling, by the device, at least one analysis operation to analyze the image data, wherein the at least one analysis operation includes an operation to perform object recognition of a first object in the image data and an operation to determine a characteristic of the first object using the image data;
controlling, by the device, at least one validation operation to verify the characteristic of the first object, the validation operation generating at least one validation output; and
controlling, by the device, output of the at least one validation output, wherein the output of the at least one validation operation includes output of at least one graphical element with the image data.

2. The method of claim 1, wherein detecting image data includes detecting image data in at least one of a data stream, display content and electronic file, and wherein the image data is received by the device.

3. The method of claim 1, wherein the at least one analysis operation to analyze image data includes detecting a lighting characteristic of the first object relative to at least one image area of the image data.

4. The method of claim 1, wherein the at least one analysis operation to analyze image data includes detecting a two-dimensional characteristic of the first object in the image data, and wherein the validation operation includes verifying the characteristic of the first object to at least one parameter characteristic for the first object.

5. The method of claim 1, wherein the at least one analysis operation to analyze image data includes detecting an inconsistency of the object in the image data.

6. The method of claim 1, wherein the at least one analysis operation to analyze image data includes detecting use of preexisting image data.

7. The method of claim 1, wherein the at least one analysis operation to analyze image data includes detecting pixel blur in the image data.

8. The method of claim 1, wherein the at least one analysis operation to analyze image data includes detecting a machine model generated element in the image data.

9. The method of claim 1, wherein the graphical element with the image data identifies at least one characteristic of the first object.

10. The method of claim 1, further comprising controlling at least one machine model to generate reference image data using the object recognition of the first object as input, and wherein controlling at least on validation operation includes comparison of the reference image data to the image data.

11. A device configured for analyzing image data, the device comprising:
an interface;
a memory storing executable instructions; and
a controller coupled to the interface and the memory, wherein the controller is configured to:
detect image data;
control at least one analysis operation to analyze the image data, wherein the at least one analysis operation includes an operation to perform object recognition of a first object in the image data and an operation to determine a characteristic of the first object using the image data;
control at least one validation operation to verify the characteristic of the first object; and
control output of the at least one validation output, wherein the output of the at least one validation operation includes output of at least one graphical element with the image data.

12. The device of claim 11, wherein detecting image data includes detecting image data in at least one of a data stream, display content and electronic file, and wherein the image data is received by the device.

13. The device of claim 11, wherein the at least one analysis operation to analyze image data includes detecting a lighting characteristic of the first object relative to at least one image area of the image data.

14. The device of claim 11, wherein the at least one analysis operation to analyze image data includes detecting a two-dimensional characteristic of the first object in the image data, and wherein the validation operation includes verifying the characteristic of the first object to at least one parameter characteristic for the first object.

15. The device of claim 11, wherein the at least one analysis operation to analyze image data includes detecting an inconsistency of the object in the image data.

16. The device of claim 11, wherein the at least one analysis operation to analyze image data includes detecting use of preexisting image data.

17. The device of claim 11, wherein the at least one analysis operation to analyze image data includes detecting pixel blur in the image data.

18. The device of claim 11, wherein the at least one analysis operation to analyze image data includes detecting a machine model generated element in the image data.

19. The device of claim 11, wherein the graphical element with the image data identifies at least one characteristic of the first object.

20. The device of claim 11, further comprising controlling at least one machine model to generate reference image data using the object recognition of the first object as input, and wherein controlling at least on validation operation includes comparison of the reference image data to the image data.
